(19) United States
(12) Patent Application Publication
(10) Pub. No.: US 2025/0180806 A1
(43) Pub. Date: Jun. 5, 2025

(54) RESONATOR, METAMATERIAL, OPTICAL ELEMENT, AND OPTICAL DEVICE

(71) Applicant: SONY GROUP CORPORATION, TOKYO (JP)

(72) Inventor: CHIH-ZONG DENG, TOKYO (JP)

(21) Appl. No.: 18/844,178

(22) PCT Filed: Mar. 6, 2023
(86) PCT No.: PCT/JP2023/008381

§ 371 Date: Sep. 5, 2024

(30) Foreign Application Priority Data
Mar. 16, 2022 (JP) 2022-041190

(51) Int. Cl. G02B 6/122

(52) U.S. Cl. CPC G02B 6/122

(57) ABSTRACT

An object of the present disclosure is to provide a zero refractive index material having no ohmic loss, high compatibility with an optical integrated circuit, and further a wide bandwidth for exhibiting a zero refractive index.

The present disclosure provides a resonator including a plurality of divided air holes in a unit cell, and the plurality of divided air holes includes two or more types of divided air holes different in dimension or shape, or both of them. The plurality of divided air holes may be provided at respective corners of the unit cell. The plurality of divided air holes has a shape in which a circular, elliptical, polygonal, or star-shaped polygonal air hole is divided. In addition, the present disclosure also provides a metamaterial including a plurality of the resonators. In addition, the present disclosure also provides an optical element and an optical device including the metamaterial.

### TECHNICAL FIELD

The present disclosure relates to a resonator, a metamaterial, an optical element, and an optical device.

### BACKGROUND ART

The zero refractive index material is different from conventional materials having a positive refractive index and has characteristics of exhibiting its unique refractive characteristics and infinite wavelength. Therefore, the zero refractive index material is expected to be applied to various aspects such as, for example, miniaturization of an optical circuit, improvement in efficiency of a quantum network, and improvement in resolution or viewing angle of a beam steering element.

As examples of zero refractive index materials, zero refractive index materials using metal, light-doped, or metal metamaterials have been reported so far. In addition, zero refractive index materials using the Dirac cone mode have also been reported. For example, Non-Patent Document 1 below discloses a waveguide based on Dirac cone dispersion. The document shows that the waveguide exhibits a zero refractive index and an infinite wavelength.

### CITATION LIST

### Non-Patent Document

Non-Patent Document 1: Direct Observation of Phase-Free Propagation in a Silicon Waveguide, Orad Reshef et al., ACS Photonics, 2017, 4 (10), 2385-2389

### SUMMARY OF THE INVENTION

### Problems to be Solved by the Invention

Examples of the zero refractive index material described above include a zero refractive index material using metal, light doped, or metal metamaterial. However, these zero refractive index materials have an ohmic loss due to the material, and there is a problem that the efficiency when used in an optical device is very low.

As a zero refractive index material for solving the problem, a zero refractive index material using a Dirac cone mode has been reported in recent years. The zero refractive index material is also called a Dirac cone zero-index metamaterial (DCZIM). The DCZIM can include, for example, a dielectric or a semiconductor, and therefore has no ohmic loss, and has high compatibility with an optical integrated circuit. However, since the zero refractive index of DCZIM is due to the resonance phenomenon, the bandwidth in which the zero refractive index appears is narrow. Since the bandwidth is narrow, an area applicable as an optical device may be limited.

In view of the above, an object of the present disclosure is to provide a zero refractive index material having no ohmic loss, high compatibility with an optical integrated circuit, and further a wide bandwidth for exhibiting a zero refractive index.

### Solutions to Problems

The present disclosure provides a resonator including:
a plurality of divided air holes in a unit cell, in which
the plurality of divided air holes includes two or more types of divided air holes different in dimension or shape, or both.

The plurality of divided air holes may be provided at respective corners of the unit cell.

The plurality of divided air holes may have a shape in which a circular, elliptical, polygonal, or star-shaped polygonal air hole is divided.

The unit cell may be a unit cell having a shape of a polygon, and a divided air hole may be provided at each of corners of the polygon.

The size of the resonator may be less than or equal to 800 nm.

The sizes of the two or more types of divided air holes may be 0.01 to 0.5 in a case where the size of the resonator is 1.

In addition, the present disclosure provides
a metamaterial including:
a resonator provided with a plurality of divided air holes in a unit cell, in which
the plurality of divided air holes provided in each of the resonators includes two or more types of divided air holes different in dimension or shape, or both.

The plurality of divided air holes may be provided at respective corners of the unit cell.

The resonators may be arranged one-dimensionally or two-dimensionally.

The resonators may be arranged periodically.

The resonators may be arranged such that at least two types of divided air holes are connected to form one air hole.

A relative bandwidth of the metamaterial may be greater than or equal to 5%.

The wavelength range over which the metamaterial exhibits a zero refractive index may be greater than or equal to 50 nm.

Each of the two or more types of divided air holes may be a divided air hole configured to exhibit a zero refractive index in a case where only one type of divided air hole is provided in all corners of the unit cell.

The metamaterial may exhibit a zero refractive index with respect to near-infrared light.

The plurality of resonators is rectangular, and a divided air hole provided in each of the plurality of resonators may have a shape in which a circle is divided.

The metamaterial may be a Dirac cone zero refractive index material.

In addition, the present disclosure also provides an optical element including the metamaterial.

The optical element may be a waveguide.

In addition, the present disclosure also provides an optical device including the metamaterial.

The optical device may be any of an optical circuit, an optical communication module, an optical information processing device, an optical information processing system, a sensor device, a measurement device, a sensing system, a laser, a cloaking device, a non-linear optical device, a quantum emitter, a beam steering device, and a device utilizing super-radiance.

### BRIEF DESCRIPTION OF DRAWINGS

FIG. 1A is a schematic view illustrating an example of a resonator and metamaterial according to the present disclosure.

FIG. 1B is a schematic view illustrating an example of a resonator and metamaterial according to the present disclosure.

FIG. 1C is a schematic view illustrating an example of metamaterial according to the present disclosure.

FIG. 2 is a schematic view of metamaterial having one type of divided air hole.

FIG. 3A is a schematic view illustrating an example of a resonator according to the present disclosure.

FIG. 3B is a schematic view illustrating an example of a resonator according to the present disclosure.

FIG. 3C is a schematic view illustrating an example of a resonator according to the present disclosure.

FIG. 3D is a schematic view illustrating an example of a resonator according to the present disclosure.

FIG. 4A is an example of a flowchart of a method for manufacturing a resonator according to the present disclosure.

FIG. 4B is a schematic view for explaining the method for manufacturing the resonator according to the present disclosure.

FIG. 5 is a view illustrating an example of metamaterial according to the present disclosure in which resonators are one-dimensionally arranged.

FIG. 6 is a view illustrating an example of metamaterial according to the present disclosure in which resonators are two-dimensionally arranged.

FIG. 7A is a view illustrating a simulation result of distribution of an out-of-plane magnetic field.

FIG. 7B is a view illustrating a simulation result of an effective wavelength.

FIG. 7C is a view illustrating a simulation result of the refractive index.

FIG. 8A is a view illustrating a simulation result of distribution of an out-of-plane magnetic field.

FIG. 8B is a view illustrating simulation results of an effective wavelength and a refractive index.

FIG. 9 is a schematic view of an example of a two-dimensional array.

FIG. 10 is a schematic view of an example of a two-dimensional array.

FIG. 11 is a view illustrating a measurement result of a refractive index.

FIG. 12A is a schematic view for explaining a function of metamaterial.

FIG. 12B is a schematic view for explaining a function of metamaterial.

FIG. 13A is a view for explaining simulation conditions.

FIG. 13B is a view for explaining how to specify a node.

FIG. 14A is a view for explaining simulation conditions.

FIG. 14B is a view for explaining how to specify a node.

### MODE FOR CARRYING OUT THE INVENTION

Hereinafter, preferred modes for carrying out the present disclosure will be described. Note that the embodiments described below illustrate representative embodiments of the present disclosure, and the scope of the present disclosure is not limited only to these embodiments.

The present disclosure will be described in the following order.
1. First Embodiment (Resonator)
1-1. Outline of Present Disclosure
1-2. Configuration Example of Resonator
1-3. Resonator Creation Method
2. Second Embodiment (Metamaterial)
3. Third Embodiment (Optical Element and Optical Device)
4. Examples
4-1. Example 1 (Exhibition of Zero Refractive Index in One-Dimensional Waveguide)
4-2. Example 2 (Exhibition of Zero Refractive Index in Two-Dimensional Array)

### 1. First Embodiment (Resonator)

### 1-1. Outline of Present Disclosure

The present inventor has found a resonator suitable for enabling to exhibit a zero refractive index over a wide bandwidth. That is, the resonator is provided with a plurality of divided air holes in a unit cell, and the plurality of divided air holes includes two or more types of divided air holes different in dimension or shape, or both. Preferably, the plurality of divided air holes is provided at respective corners of the unit cell. The structure having a plurality of resonators can exhibit a zero refractive index over a wide bandwidth with respect to, for example, electromagnetic waves and elastic waves. For example, the present disclosure provides metamaterial that exhibits zero refractive index over a wide bandwidth.

According to the present disclosure, a zero refractive index can be exhibited over a wide band, for example, a relative bandwidth of 5% to 15%. Furthermore, it is possible to exhibit a zero refractive index and an infinite wavelength over the wide band.

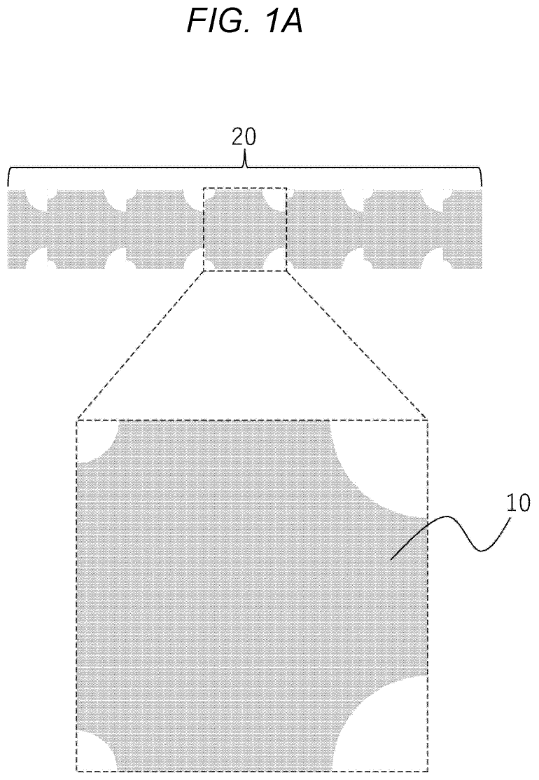

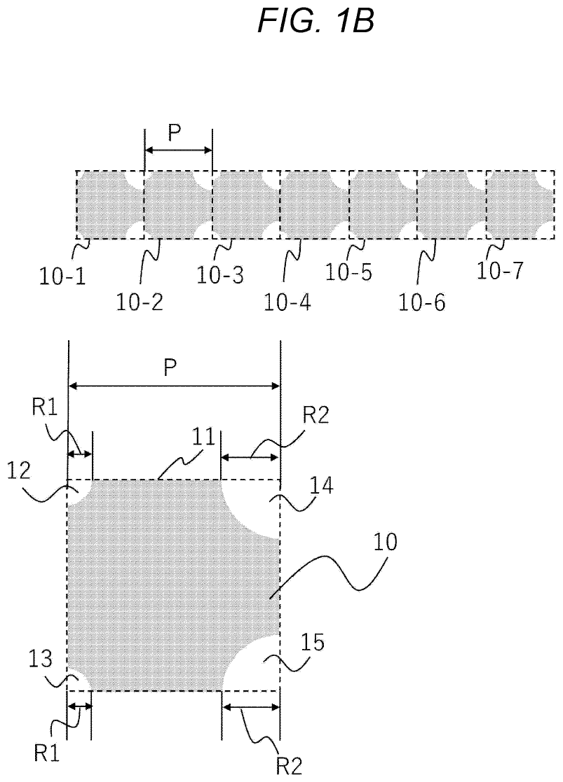

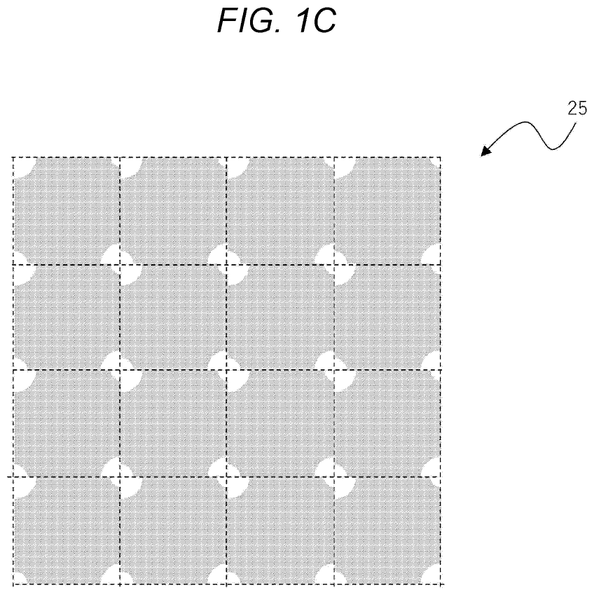

An example of a structure of a resonator according to the present disclosure will be described with reference to FIGS. 1A and 1B. FIG. 1A illustrates a resonator 10 according to the present disclosure and a waveguide 20 in which the resonators are periodically arranged. Each element illustrated in the drawing will be described with reference to FIG. 1B.

In the waveguide 20, as illustrated in FIG. 1B, a plurality of resonators 10-1 to 10-7 is one-dimensionally arranged. The number of resonator unit cells arranged in the waveguide 20 is not limited to the number (seven) illustrated in the drawing, and may be, for example, two or more. The number of resonators arranged in the waveguide 20 may be preferably 3 or more, 4 or more, or 5 or more in order to exhibit a zero refractive index. By arranging a plurality of unit cells, particularly by periodically arranging the unit cells, a zero refractive index is exhibited. The upper limit of the number of arranged resonators is not necessarily limited, but may be, for example, 10,000 or less, 5,000 or less, 1,000 or less, 500 or less, or 100 or less.

A unit cell 11 of the resonator 10 has a rectangular shape as indicated by a dotted line in the drawing. The rectangle may be square or oblong. Divided air holes 12 to 15 are provided at respective four corners of the rectangular unit cell.

The divided air holes 12 and 13 have a shape in which a circle (also referred to as an “original circle”) is divided into four, that is, a shape of a ¼ circle (also referred to as a “quadrant circle”). Each radius of the ¼ circle of the divided air holes 12 and 13 is R1. The ¼ circles of the divided air holes 12 and 13 are arranged such that the center of the original circle is located at the corner of the unit cell (that is, near the angular corner of the rectangle).

The divided air holes 14 and 15 also have a shape in which a circle (also referred to as an “original circle”) is divided into four, that is, a shape of a ¼ circle (quadrant circle). Each radius of the ¼ circle of the divided air holes 14 and 15 is R2. The ¼ circles of the divided air holes 14 and 15 are arranged such that the center of the original circle is located at the corner of the unit cell (near the angular corner of the rectangle).

The radius R1 of the ¼ circle of the divided air holes 12 and 13 is smaller than the radius R2 of the ¼ circle of the divided air holes 14 and 15. As described above, the divided air holes 12 to 15 provided at the four corners of the rectangle of the unit cell 11 are different in dimension (more specifically, radius). On the other hand, the shapes of the divided air holes 12 to 15 are the same, and all are ¼ circles.

As described above, the two different types of divided air holes are provided at the corners of each unit cell. Then, as illustrated in the upper part of the drawing, the unit cell 10-1 and the unit cell 10-2 are arranged side by side such that two types of divided air holes having different dimensions (in particular, radius) are connected, in particular, the two types of divided air holes are connected to form one air hole.

Similarly, the other two unit cells (for example, the unit cell 10-2 and the unit cell 10-3) arranged side by side are arranged such that two different types of divided air holes are connected.

As described above, in the present disclosure, the plurality of resonators is arranged such that two or more different types of divided air holes are connected, particularly two or more types of divided air holes are connected to form one air hole. Such an arrangement contributes to widening the wavelength range in which the zero refractive index is exhibited. For example, it is possible to exhibit a zero refractive index and an infinite wavelength over a wide band of a relative bandwidth of 5% or more, particularly a relative bandwidth of 5% to 15%.

In addition, the resonators according to the present disclosure may be arranged two-dimensionally. For example, as illustrated in FIG. 1C, a zero refractive index can be exhibited over a wide wavelength range by two-dimensionally arranging a plurality of resonators according to the present disclosure. In a two-dimensional array 25 illustrated in the drawing, the resonators 10 described above are arranged in both the longitudinal direction and the lateral direction.

In addition, in the two-dimensional array 25, the plurality of resonators is arranged such that two or more different types of divided air holes are connected, particularly two or more types of divided air holes are connected to form one air hole. Such an arrangement contributes to widening the wavelength range in which the zero refractive index is exhibited. For example, it is possible to exhibit a zero refractive index and an infinite wavelength over a wide band of a relative bandwidth of 5% or more, particularly a relative bandwidth of 5% to 15%.

In the present specification, the “zero refractive index” means that the absolute value of a refractive index n is less than 0.1, that is, represented by the following Expression (1).

$$\begin{matrix}[ Math . 1 ] & \\ \vert n \vert < 0.1 & ( 1 )\end{matrix}$$

The bandwidth of the wavelength at which the metamaterial configured by the resonators according to the present disclosure exhibits a zero refractive index may be, for example, 50 nm or more, preferably 55 nm or more, more preferably 60 nm or more, or 65 nm or more, and still more preferably 70 nm or more, 75 nm or more, or 80 nm or more. The bandwidth may further be 100 nm or more, 110 nm or more, 120 nm or more, or 130 nm or more.

In addition, the upper limit of the bandwidth of the wavelength at which the metamaterial configured by the resonators according to the present disclosure exhibits a zero refractive index is not particularly limited, but may be, for example, 200 nm or less, 190 nm or less, 180 nm or less, 170 nm or less, 160 nm or less, or 150 nm or less.

The bandwidth of the wavelength at which the metamaterial configured by the resonators according to the present disclosure exhibits a zero refractive index may be selected from the upper limit and the lower limit described above, and may be, for example, 50 nm or more and 200 nm or less, 60 nm or more and 190 nm or less, or 70 nm or more and 180 nm or less.

The bandwidth of the wavelength at which the metamaterial exhibits a zero refractive index is specified on the basis of a refractive index n measured in a case where light of each wavelength is incident. The bandwidth is a wavelength range in which the refractive index n is in a range satisfying the above Expression (1).

The method for measuring the refractive index n is selected according to the arrangement of resonators in the metamaterial as described below.

(Refractive Index Measurement Method 1: Case where Resonators are Arranged One-Dimensionally)

In the metamaterial, in a case where the resonators are arranged one-dimensionally (for example, in a case where the metamaterial is a one-dimensional waveguide), the refractive index n is measured according to the method described in Non-Patent Document 1 (Direct Observation of Phase-Free Propagation in a Silicon Waveguide, Orad Reshef et al., ACS Photonics, 2017, 4 (10), 2385-2389). That is, the refractive index n of the metamaterial (in particular, the waveguide medium) can be obtained by detecting the standing wave generated from both ends (in particular, both ends of the waveguide) of the one-dimensional arrangement. An inter-node distance Δz of the standing wave observed by this method satisfies the relationship of the following Expression (2) in a case where the wavelength in free space is λ₀.

$$\begin{matrix}[ Math . 2 ] & \\ Δ z = ( {λ}_{0} / 2 n ) & ( 2 )\end{matrix}$$

(Refractive Index Measurement Method 2: Case where Resonators are Two-Dimensionally Arranged)

In the metamaterial, in a case where the resonators are two-dimensionally arranged (for example, in a case where the metamaterial is a two-dimensional array material), a refractive index n (referred to as “n₁” in this measurement method) is measured according to the method described in Monolithic CMOS-compatible zero-index metamaterials, DARYL I. VULIS et al., Optics Express, 2017, 25 (11), 12381-12399. In the method, the refractive index n₁ is determined from the following Expression (3) according to Snell's law if the refractive index of the material to be measured (metamaterial) is n₁, the refractive index of the material adjacent to the material to be measured is n₂, the incident angle is θ₁, and the emission angle is θ₂.

$$\begin{matrix}[ Math . 3 ] & \\ {n}_{1} sin {θ}_{1} = {n}_{2} sin {θ}_{2} & ( 3 )\end{matrix}$$

A relative bandwidth of a wavelength at which metamaterial configured by resonators according to the present disclosure exhibits a zero refractive index may be, for example, 5% or more, preferably 5.5% or more, more preferably 6% or more, or 6.5% or more, and still more preferably 7% or more, 7.5% or more, or 8.0% or more.

In addition, the upper limit of the relative bandwidth of the wavelength at which the metamaterial configured by the resonators according to the present disclosure exhibits the zero refractive index is not particularly limited, but may be, for example, 15% or less, 14% or less, or 13% or less.

The relative bandwidth of the wavelength at which the metamaterial configured by the resonators according to the present disclosure exhibits the zero refractive index may be selected from the upper limit and the lower limit described above, and may be, for example, 5% or more and 15% or less, 5.5% or more and 14% or less, or 6.0% or more and 13% or less.

### (Relative Bandwidth Measurement Method)

The relative bandwidth is calculated on the basis of a bandwidth of a wavelength at which the metamaterial described above exhibits a zero refractive index. Specifically, it is calculated from the following Expression (4). A method for specifying the bandwidth of the wavelength that exhibits the zero refractive index is as described above.

$$( relative bandwidth ( \% ) ) = ( Bandwidth of Wavelength Exhibiting Zero Refractive Index ) / ( Central Wavelength of Band Exhibiting Zero Refractive Index ) \times 100 \qquad ( 4 )$$

(Wavelength of Light at which Zero Refractive Index is Exhibited)

The light for which the metamaterial configured by resonators according to the present disclosure exhibits a zero refractive index may be, for example, infrared light, in particular, near-infrared light, mid-infrared light, or far-infrared light, and preferably near-infrared light or mid-infrared light.

In one embodiment, the light for which the metamaterial configured by resonators according to the present disclosure exhibits a zero refractive index may be near-infrared light, that is, light having a wavelength of 800 nm to 2500 nm, preferably light having a wavelength of 900 nm to 2400 nm, more preferably light having a wavelength of 1000 nm to 2000 nm.

In one embodiment, the light exhibiting a zero refractive index may be, for example, light having a wavelength of 1200 nm to 1800 nm, more preferably light having a wavelength of 1300 nm to 1700 nm, still more preferably light having a wavelength of 1400 nm to 1700 nm, and particularly light having a wavelength of 1450 nm to 1650 nm.

In another embodiment, the light for which the metamaterial configured by resonators according to the present disclosure exhibits a zero refractive index may be mid-infrared light, and may be, for example, 2500 nm to 4000 nm.

The metamaterial configured by resonators according to the present disclosure can exhibit a zero refractive index for light in such a wavelength range.

### (Description of Effect of Present Disclosure)

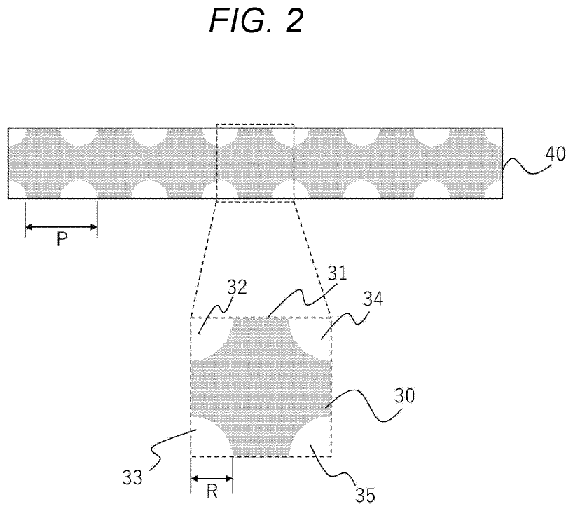

As one of metamaterial structures, there is an air hole array waveguide. The waveguide has a structure in which air holes are arranged, and a silicon thin-film region between the air holes is used as a resonator by the structure. The metamaterial structure is designed such that confinement to a TE mode propagating in the waveguide into the silicon thin-film layer efficiently occurs. An example of a structure of such a waveguide is illustrated in FIG. 2.

A waveguide 40 illustrated in the drawing has a plurality of resonators 30 arranged one-dimensionally. The resonator 30 is configured as a rectangular unit cell 31, and the unit cell has four divided air holes 32 to 35. Each of the divided air holes 32 to 35 is a ¼ circle, and has the same dimension and shape. By optimizing the size (in particular, radius) and the array period of the divided air holes, a mode based on the Dirac cone variance occurs. Such a waveguide is described in Non-Patent Document 1 described above, and it is illustrated that the waveguide exhibits a zero refractive index and an infinite wavelength.

However, in such a waveguide, the relative bandwidth exhibiting the zero refractive index is very narrow, for example, about 2%.

As described above, the resonator according to the present disclosure includes two or more types of divided air holes. The metamaterial in which the plurality of resonators is arranged can exhibit a zero refractive index over a very wide bandwidth by the two or more types of divided air holes. That is, the relative bandwidth of the metamaterial can be expanded. The zero refractive index exhibition over a wide bandwidth by the metamaterial is illustrated in the examples described below.

### 1-2. Configuration Example of Resonator

A configuration example of a resonator according to the present disclosure will be described with reference to FIG. 1B described above.

### (Dimensions of Resonator)

As illustrated in the drawing, a size P of the resonator may be a size in the periodic direction of the unit cell. Since the size P of the resonator corresponds to the period of the arranged unit cells, it may also be referred to as a period P.

The size P of the resonator may mean, for example, a maximum dimension of the unit cell in a direction in which light is guided (for example, in a case where the resonators are arranged one-dimensionally), or may mean a maximum dimension of the unit cell in a direction orthogonal to a surface on which light is incident or emitted (for example, in a case where the resonators are arranged two-dimensionally).

The size P of the resonator according to the present disclosure may be, for example, 500 nm or more, preferably 505 nm or more, more preferably 510 nm or more, and still more preferably 515 nm or more, 520 nm or more, or 525 nm or more.

The size P may be, for example, 800 nm or less, preferably 780 nm or less, more preferably 770 nm or less, and still more preferably 765 nm or less, 760 nm or less, 755 nm or less, or 750 nm or less.

The size P of the resonator according to the present disclosure may be selected from the upper limit and the lower limit listed above, and may be, for example, 500 nm or more and 800 nm or less, 510 nm or more and 780 nm or less, or 515 nm or more and 765 nm or less.

For example, in a case where the shape of the unit cell is a square or an oblong, the size P may be a length of one side of the square or a length of a long side or a short side of the oblong.

Note that, in the present specification, the “shape of a unit cell” means a shape of a unit cell assuming a state where no divided air hole is provided, and corresponds to a shape indicated by a dotted line in the drawing.

The description regarding the numerical range described for the size P described above also applies to the size of the resonator in the direction orthogonal to the size P of the resonator.

For example, in a case where the shape of the unit cell is a square or oblong, the size in the orthogonal direction may be a length of one side of the square or a length of a short side or a long side of the oblong.

### (Dimensions of Divided Air Hole)

A size R1 of the divided air hole (for example, the maximum dimension of the divided air hole in the direction in which the light is guided) may be, for example, 0.01 to 0.5, preferably 0.05 to 0.4, and more preferably 0.01 to 0.3 in a case where the size P of the resonator is 1.

For example, in a case where the shape of the divided air hole is a divided circle, the size R1 of the divided air hole may be the radius of the original circle.

For example, in a case where the shape of the air hole is a divided rectangle, the size R1 of the divided air hole may be one side or a long side of the divided rectangle.

The size R1 of the divided air hole may be, for example, 15 nm or more, preferably 20 nm or more, more preferably 30 nm or more, 40 nm or more, or 50 nm or more.

The size R1 of the divided air hole may be, for example, 245 nm or less, preferably 200 nm or less, more preferably 180 nm or less, and still more preferably 150 nm or less.

The size R2 of the divided air hole (for example, the maximum dimension of the divided air hole in the direction in which the light is guided) is different from R1, and may be larger or smaller than R1, for example. A size R2 of the divided air hole (for example, the maximum dimension of the divided air hole in the direction in which the light is guided) may be, for example, 0.01 to 0.5, preferably 0.05 to 0.4, and more preferably 0.01 to 0.3 in a case where the size P of the resonator is 1.

For example, in a case where the shape of the divided air hole is a divided circle, the size R2 of the divided air hole may be the radius of the original circle.

For example, in a case where the shape of the air hole is a divided rectangle, the size R2 of the divided air hole may be one side or a long side of the divided rectangle.

The size R2 of the divided air hole may be, for example, 15 nm or more, preferably 20 nm or more, more preferably 30 nm or more, 40 nm or more, or 50 nm or more, and still more preferably 60 nm or more, 70 nm or more, or 80 nm or more.

The size R2 of the divided air hole may be, for example, 245 nm or less, preferably 240 nm or less, more preferably 235 nm or less, and still more preferably 230 nm or less.

### (Shape of Unit Cell and Divided Air Hole)

In one embodiment, the shape of the unit cell of the resonator may be, for example, a polygon. The polygon is, for example, a rectangle, and may be particularly a square or an oblong. The polygon is not limited to a rectangle, and may be, for example, another polygon. The polygon may be, for example, a triangle, a quadrangle other than a rectangle, a pentagon, a hexagon, or the like. Note that, in the present specification, a “polygon” does not include a “star polygon” described later.

In this embodiment, the divided air hole may be preferably provided at the respective corners of the polygon. Two or more types of divided air holes different in dimension or shape or both may be provided at the corners (also referred to as angular corners) of the polygon. For example, the dimension or shape of the divided air hole provided in some corners of all the corners of the polygon, or both of them may be different from those of the divided air holes provided in the remaining corners.

In a case where the polygon is a triangle, at a corner of the triangle, two or more types (2 or 3 types, particularly 2 types) of divisions different in dimension, shape, or both may be provided. For example, the dimension or shape of the divided air hole provided at one angular corner of the three corners or both of them may be different from those of the divided air holes provided at the other two corners.

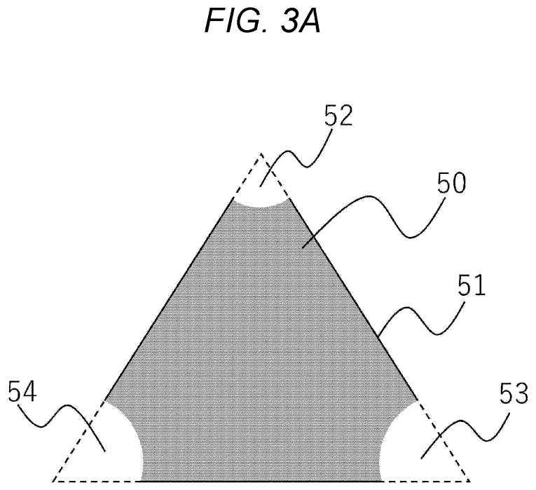

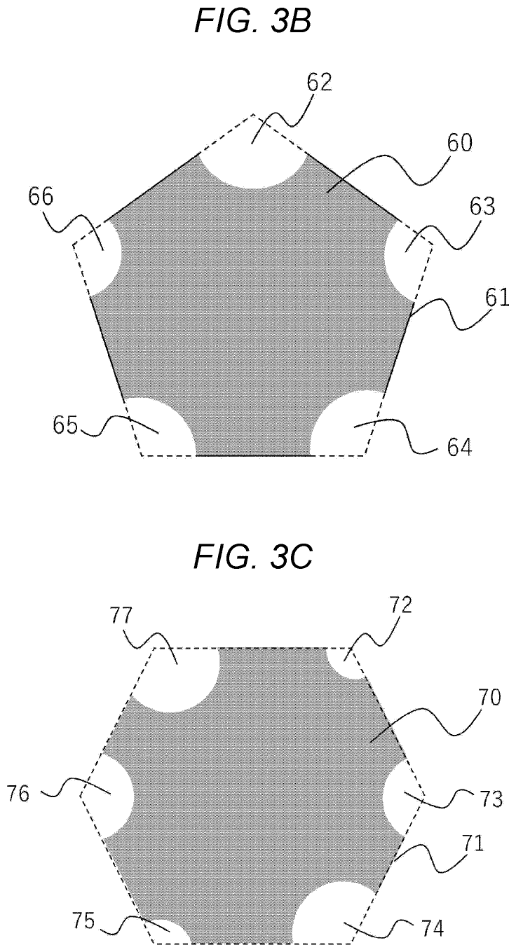

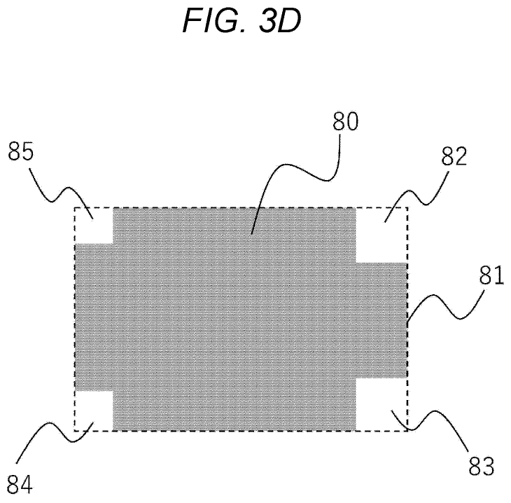

FIG. 3A illustrates a configuration example of a resonator in which a unit cell has a triangular shape. A unit cell 51 of a resonator 50 illustrated in the drawing has a triangle as indicated by a dotted line in the drawing. The triangle may be, for example, an equilateral triangle or an isosceles triangle. Divided air holes 52 to 54 are provided at the respective three corners of the triangle.

The divided air hole 52 has a shape in which a circle (also referred to as an “original circle”) is divided into six, that is, a shape of a ⅙ circle.

The radius of the ⅙ circle of the divided air hole 52 is R1.

The ⅙ circle of the divided air hole 52 is disposed such that the center of the original circle is located at the corner of the unit cell (that is, near the angular corner of the triangle).

The divided air holes 53 and 54 have a shape in which a circle (also referred to as an “original circle”) is divided into six, that is, a shape of a ⅙ circle.

The radius of the ⅙ circle of the divided air holes 53 and 54 is R2.

The ⅙ circles of the divided air holes 53 and 54 are arranged such that the center of the original circle is located at the corner of the unit cell (that is, near the angular corner of the triangle).

The radius R1 of the ⅙ circle of the divided air hole 52 is smaller than the radius R2 of the ⅙ circles of the divided air holes 53 and 54.

As described above, the divided air holes 52 to 54 provided at the three corners of the triangle of the unit cell 51 are different in dimension (more specifically, radius). On the other hand, the shapes of the divided air holes 52 to 54 are the same, and both are ⅙ circles.

In addition, in FIG. 3A, an equilateral triangle is illustrated as an example of the shape of the unit cell, and accordingly, the shapes of the three divided air holes are the same. As described above, the shape of the unit cell may be an isosceles triangle, and in this case, the shapes of the three divided air holes may be different. For example, the shapes of the divided air holes 53 and 54 described above may be the same, and the shapes may be different from the shape of the divided air hole 52.

As described above, since the two types of divided air holes having different dimensions are provided at the corners of the unit cell, the wavelength range in which the zero refractive index is exhibited is widened.

In a case where the polygon is a quadrangle (for example, a rectangle), two or more types (2 types, 3 types, or 4 types; particularly, two types) of divided air holes different in dimension or shape or both may be provided at corners of the quadrangle. For example, the dimension or shape of the divided air hole provided in some of the four corners (1, 2, or 3 corners: particularly 2 corners) or both of them may be different from the divided air holes provided in the remaining corners (3, 2 or 1 corner; particularly 2 corners).

In a case where the polygon is a pentagon, two or more types (2 types, 3 types, 4 types, or 5 types, particularly 2 types or 3 types) of divided air holes different in dimension, shape, or both may be provided at corners of the pentagon. For example, the dimension or shape of the divided air hole provided in some corners (1, 2, 3, or 4 corners) of the five corners or both of them may be different from the divided air hole provided in the remaining angular corners (4, 3, 2, or 1 corner) of the five corners.

A configuration example of a resonator in which a unit cell has a pentagonal shape is illustrated in FIG. 3B. A unit cell 61 of a resonator 60 illustrated in the drawing has a pentagon as indicated by a dotted line in the drawing. Divided air holes 62 to 66 are provided at the respective five corners of the pentagon.

The divided air holes 62, 64, and 65 have a shape in which a circle (also referred to as an “original circle”) is divided.

The radius of the partial circle of the divided air holes 62, 64, and 65 is R1.

The partial circles of the divided air holes 62, 64, and 65 are arranged such that the center of the original circle is located at a corner (that is, a pentagonal angular corner) of the unit cell.

The divided air holes 63 and 66 have a shape in which a circle (also referred to as an “original circle”) is divided.

The radius of the partial circles of the divided air holes 63 and 66 is R2.

The partial circles of the divided air holes 63 and 66 are arranged such that the center of the original circle is located at a corner (that is, a pentagonal angular corner) of the unit cell.

The radius R1 of the partial circles of the divided air holes 62, 64, and 65 is larger than the radius R2 of the partial circles of the divided air holes 63 and 66.

As described above, the divided air holes 62 to 66 provided at the five corners of the pentagon of the unit cell 61 are different in dimension (more specifically, radius). On the other hand, the shapes of the divided air holes 62 to 66 are the same.

In addition, the shapes of the five divided air holes may be the same or different.

As described above, the two or more types of divided air holes having different dimensions and/or shapes are provided at the corners of the unit cells, whereby the wavelength range in which the zero refractive index is exhibited is widened.

In a case where the polygon is a hexagon, two or more types (2 types, 3 types, 4 types, 5 types, or 6 types; particularly, 2 or 3 types) of divided air holes different in dimension, shape, or both may be provided at corners of the hexagon. For example, the dimension or shape of the divided air hole provided in some corners (1, 2, 3, 4, or 5 corners) of the six corners or both of them may be different from the divided air hole provided in the remaining corners (5, 4, 3, 2, or 1 corner) of the six corners.

FIG. 3C illustrates a configuration example of a resonator in which a unit cell has a hexagonal shape. A unit cell 71 of a resonator 70 illustrated in the drawing has a hexagonal shape as indicated by a dotted line in the drawing. Divided air hole 72 to 77 are provided at the respective six corners of the hexagon.

The divided air holes 72 and 75 have a shape in which a circle (also referred to as an “original circle”) is divided.

The radius of the partial circle of the divided air holes 72 and 75 is R1.

The partial circles of the divided air holes 72 and 75 are arranged such that the center of the original circle is located at a corner (that is, a hexagonal angular corner) of the unit cell.

The divided air holes 73 and 76 have a shape in which a circle (also referred to as an “original circle”) is divided.

The radius of the partial circles of the divided air holes 73 and 76 is R2.

The partial circles of the divided air holes 73 and 76 are arranged such that the center of the original circle is located at a corner (that is, a hexagonal angular corner) of the unit cell.

The divided air holes 74 and 77 have a shape in which a circle (also referred to as an “original circle”) is divided.

The radius of the partial circles of the divided air holes 74 and 77 is R3.

The partial circles of the divided air holes 74 and 77 are arranged such that the center of the original circle is located at a corner (that is, a hexagonal angular corner) of the unit cell.

The radii R1, R2, and R3 have a relationship of R1<R2<R3. As described above, the divided air holes 72 to 77 provided at the six corners of the hexagon of the unit cell 71 are different in dimension (more specifically, radius). On the other hand, the shapes of the divided air holes 72 to 77 are the same.

In addition, the shapes of the six divided air holes may be the same or different.

As described above, the two or more types of divided air holes having different dimensions and/or shapes are provided at the corners of the unit cells, whereby the wavelength range in which the zero refractive index is exhibited is widened.

In addition, the shape of the divided air hole is not limited to the divided circle, and may be another shape such as a rectangle. This example is illustrated in FIG. 3D. A unit cell 81 of a resonator 80 illustrated in the drawing has a quadrangle (oblong) as indicated by a dotted line in the drawing. Divided air holes 82 to 85 are provided at the respective four corners of the quadrangle.

The divided air holes 82 and 83 have a shape in which a quadrangle (also referred to as an “original quadrangle”) is divided.

The long side of the quadrangle of the divided air holes 82 and 83 is R2.

The divided air holes 84 and 85 have a shape in which a quadrangle (also referred to as an “original quadrangle”) is divided.

The long side of the quadrangle of the divided air holes 84 and 85 is R1.

R1 and R2 have a relationship of R1<R2. As described above, the divided air holes 82 to 85 provided at the four corners of the quadrangle of the unit cell 81 are different in dimension (more specifically, radius).

As described above, the shapes of the two or more types of divided air holes are not limited to the divided circular shapes, and may be other shapes. For example, the divided air hole may have a shape in which a circular, elliptical, polygonal, or star-shaped polygonal air hole is divided.

In another embodiment, the shape of the unit cell of the resonator may be a star polygon, for example, a star pentagon, a star hexagon, a star heptagon, or a star octagon.

In this embodiment, the divided air holes may be preferably provided at all corners (in particular, acute-angle vertices) of the star polygon. Two or more types of divided air holes different in dimension or shape or both may be provided at the corners of the star polygon. For example, the dimension or shape of the divided air hole provided in some corners of all the corners of a part of the polygon, or both of them may be different from those of the divided air holes provided in the remaining corners.

In a case where the star polygon is a star pentagon, two or more (2 types, 3 types, 4 types, or 5 types, particularly 2 types or 3 types) divided air holes different in dimension, shape, or both may be provided at an acute-angle vertex of the star pentagon. For example, a dimension or a shape of a divided air hole provided at an acute-angle vertex (1, 2, 3 or 4 acute-angle vertices) of a part of the five acute-angle vertices, or both of them may be different from that of a divided air hole provided at the remaining acute-angle vertices (4, 3, 2, or 1 acute-angle vertex) of the five acute-angle vertices.

In a case where the star polygon is a star hexagon, two or more (2 types, 3 types, 4 types, 5 types, or 6 types, particularly 2 types or 3 types) divided air holes different in dimension, shape, or both may be provided at an acute-angle vertex of the star hexagon. For example, a dimension or a shape of a divided air hole provided at an acute-angle vertex (1, 2, 3, 4, or 5 acute-angle vertices) of a part of the six acute-angle vertices, or both of them may be different from that of a divided air hole provided at the remaining acute-angle vertices (5, 4, 3, 2, or 1 acute-angle vertex) of the six acute-angle vertices.

Preferably, in the present disclosure, each of the divided air holes provided at the corner of the unit cell is a divided air hole configured to exhibit a zero refractive index in a case where only one type of divided air hole is provided at all corners of the unit cell. The wavelength at which the zero refractive index is exhibited varies depending on the dimension and shape of the divided air hole. As described above, the bandwidth at which the zero refractive index is exhibited can be widened by providing two or more types of divided air holes having different wavelengths at which the zero refractive index is exhibited at the corners of the unit cell.

For example, in a case where there are two types of divided air holes provided at one or more corners of a unit cell,
one type of divided air hole is a divided air hole configured to exhibit a zero refractive index for light of a certain wavelength in a case where the divided air hole is provided at all corners of the unit cell, and
the other type of divided air hole is a divided air hole configured to exhibit a zero refractive index for light of another wavelength in a case where the other type of divided air hole is provided at all corners of the unit cell.

For example, in a case where there are three types of divided air holes provided at one or more corners of a unit cell,
one type of divided air hole may be a divided air hole configured to exhibit a zero refractive index for light of a certain wavelength in a case where the divided air hole is provided at all corners of the unit cell,
another type of divided air hole may be also a divided air hole configured to exhibit a zero refractive index for light of another wavelength in a case where the divided air hole is provided at all corners of the unit cell, and
the last one type of divided air hole may also be a divided air hole configured to exhibit a zero refractive index for light of another wavelength in a case where the divided air hole is provided at all corners of the unit cell.

### 1-3. Resonator Creation Method

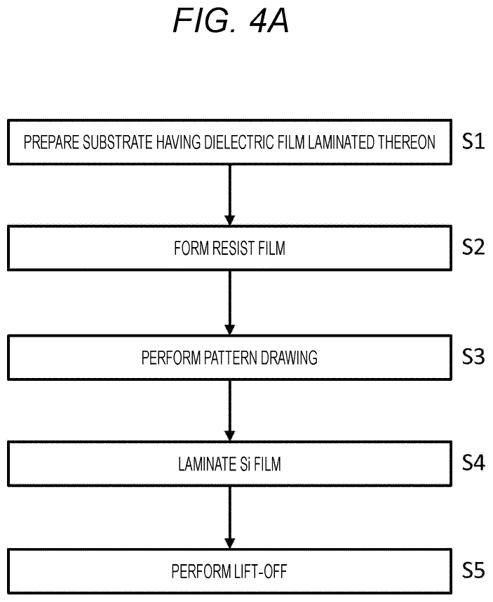

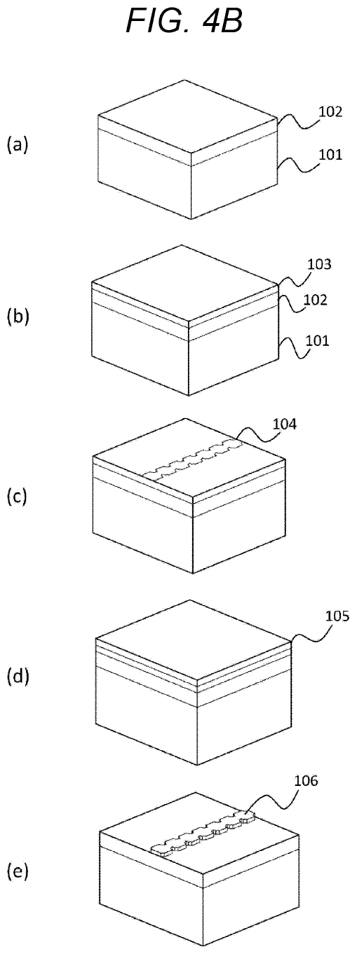

The resonator can be manufactured by an electron beam lithography method. In the manufacturing, a lithography technique known in the art may be applied, and a person skilled in the art can appropriately select a manufacturing method according to a desired resonator. A method for producing a resonator using the electron beam lithography method will be described below with reference to FIGS. 4A and 4B. FIG. 4A is an example of a flowchart of the producing method. FIG. 4B is a schematic view for explaining the producing method.

In step S1, a substrate 101 having a SiO₂ film 102 is prepared. The substrate 101 may be, for example, a silicon substrate, but may be a resin substrate. The film thickness of the film 102 may be, for example, 1 μm to 5 μm, particularly 2 μm to 4 μm. The material of the film 102 is not limited to SiO₂. The film 102 may include, for example, a material exhibiting a low refractive index and low absorption for light in a desired wavelength range. The film 102 may be, for example, a film of any material of CaF₂, Al₂O₃, and various metal oxides. These specific examples are suitable for zero refractive index exhibition in, for example, near-infrared light and mid-infrared light.

In step S2, a resist film 103 is formed on the film 102. The resist film is formed by, for example, applying an electron beam resist dissolved in a solvent by a spin coating method so as to have a predetermined film thickness after film formation, and then forming a film. The film thickness after film formation may be, for example, 200 nm to 600 nm, preferably 300 nm to 500 nm. The electron beam resist may be, for example, a resist containing a polymer of α-chloroacrylic acid ester and α-methylstyrene. Examples of such a resist include ZEP520A (Zeon Corporation), but are not limited thereto. The solvent may be, for example, N-amyl acetate. After the film formation, the resist film may be cleaned with, for example, methyl isobutyl ketone and isopropyl alcohol. After such cleaning, the next pattern drawing is performed.

In step S3, pattern drawing is performed by the electron beam so that the structure of the resonator according to the present disclosure is drawn. The pattern drawing may be performed such that the structure of the resonator according to the present disclosure is arranged one-dimensionally or two-dimensionally. In the drawing, a waveguide structure 104 in which resonators according to the present disclosure are one-dimensionally arranged is illustrated.

In step S4, a dielectric or semiconductor film 105 is laminated by a vapor deposition method. The film thickness of the film 105 after film formation may be, for example, 100 nm to 300 nm, preferably 150 nm to 250 nm. The dielectric forming the film 105 may be, for example, Si, but is not limited thereto. The film 105 may include, for example, a material exhibiting a low refractive index and low absorption for light in a desired wavelength range. The dielectric forming the film 105 may be, for example, Ge, Si₃N₄, ZnS, or GaN.

The resist film in the portion of the waveguide structure 104 is removed by pattern drawing in step S3. Then, in step S4, for example, Si is deposited so as to form the waveguide structure 104 in the portion from which the resist film has been removed.

In step S5, lift-off processing using dimethylacetamide is performed on the laminated substrate at room temperature. In this way, a resonator 106 (metamaterial in which the resonators are arranged) according to the present disclosure is manufactured.

As described above, in the present disclosure, the resonator may include a material such as a dielectric or a semiconductor. As an example of such a material, Si can be exemplified as described above, and the material may be Ge, Si₃N₄, ZnS, or GaN.

In addition, the resonator according to the present disclosure may be provided on the substrate as described above, and more particularly may be provided on a film provided on the substrate.

### 2. Second Embodiment (Metamaterial)

The present disclosure also provides a metamaterial including a plurality of resonators according to the present disclosure. The metamaterial may be, for example, a Dirac cone zero refractive index material. The resonator is as described in 1 above, and the description also applies to the present embodiment. That is, the present disclosure provides a metamaterial including a plurality of resonators provided with a plurality of divided air holes in a unit cell. Here, the plurality of divided air holes provided respectively includes two or more types of divided air holes different in dimension or shape, or both. The plurality of divided air holes may be provided at respective corners of the unit cell.

In the metamaterial according to the present disclosure, a plurality of resonators according to the present disclosure may be arranged one-dimensionally or two-dimensionally. In addition, the plurality of resonators may be periodically arranged.

The metamaterial in which the resonators according to the present disclosure are one-dimensionally arranged may be used as, for example, a waveguide. In the waveguide, light can be guided without changing the phase of the wave.

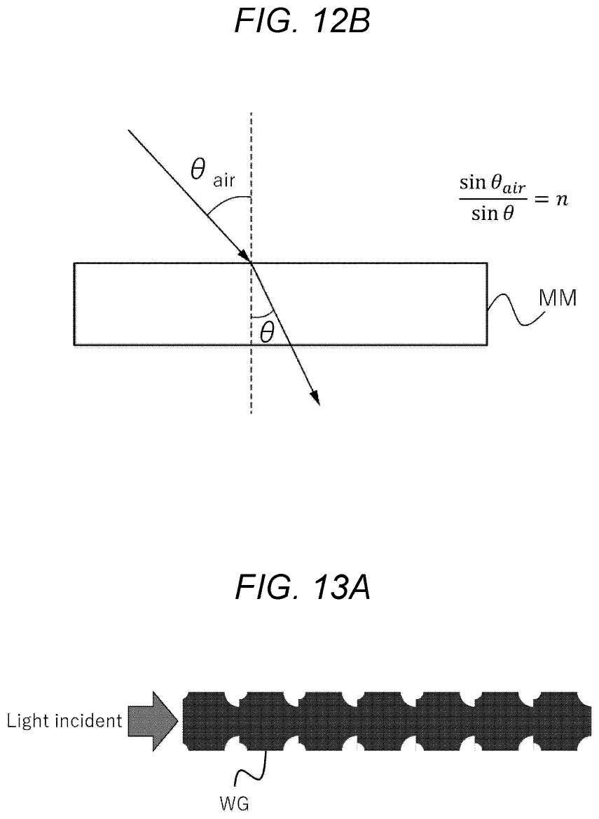

For example, as illustrated in FIG. 12A, from the viewpoint of wave optics, a metamaterial MM according to the present disclosure exhibits a function that the phase of the wave does not change.

The metamaterial in which the resonators according to the present disclosure are two-dimensionally arranged may be used, for example, as a component for imparting an optical characteristic to an optical element. For example, the two-dimensionally arranged metamaterial may be provided on the surface of the optical element. The optical element having the metamaterial can cause, for example, incident light to travel in a vertical direction.

For example, as illustrated in FIG. 12B, from the viewpoint of ray optics, the metamaterial MM according to the present disclosure exerts a function that light travels perpendicularly to an incident surface even if the light is incident at any incident angle. As can be seen from the expression relating to the refractive index n illustrated in the drawing, θ=0° in a case where n=0.

The metamaterial according to the present disclosure may exhibit a zero refractive index over a wavelength bandwidth of, for example, 50 nm or more, preferably 55 nm or more, more preferably 60 nm or more, or 65 nm or more, and still more preferably 70 nm or more, 75 nm or more, or 80 nm or more.

The upper limit value of the wavelength bandwidth is not particularly limited, but may be, for example, 200 nm or less, 190 nm or less, 180 nm or less, 170 nm or less, 160 nm or less, or 150 nm or less.

The bandwidth of the wavelength at which the metamaterial according to the present disclosure exhibits a zero refractive index may be selected from the upper limit and the lower limit described above, and may be, for example, 50 nm or more and 200 nm or less, 60 nm or more and 190 nm or less, or 70 nm or more and 180 nm or less.

The bandwidth of the wavelength at which the metamaterial exhibits a zero refractive index may be measured as described in 1 above, and is selected depending on the arrangement of resonators in the metamaterial.

A relative bandwidth of a wavelength at which metamaterial according to the present disclosure exhibits a zero refractive index may be, for example, 5% or more, preferably 5.5% or more, more preferably 6% or more, or 6.5% or more, and still more preferably 7% or more, 7.5% or more, or 8.0% or more.

In addition, the upper limit of the relative bandwidth of the wavelength at which the metamaterial according to the present disclosure exhibits the zero refractive index is not particularly limited, but may be, for example, 15% or less, 14% or less, or 13% or less.

The relative bandwidth of the wavelength at which the metamaterial according to the present disclosure exhibits the zero refractive index may be selected from the upper limit and the lower limit described above, and may be, for example, 5% or more and 15% or less, 5.5% or more and 14% or less, or 6.0% or more and 13% or less.

The relative bandwidth may be determined as described in 1.

The light for which the metamaterial according to the present disclosure exhibits a zero refractive index is, for example, near-infrared light, that is, light having a wavelength of 800 nm to 2500 nm, preferably light having a wavelength of 900 nm to 2400 nm, more preferably light having a wavelength of 1000 nm to 2000 nm.

In one embodiment, the light exhibiting a zero refractive index may be, for example, light having a wavelength of 1200 nm to 1800 nm, more preferably light having a wavelength of 1300 nm to 1700 nm, still more preferably light having a wavelength of 1400 nm to 1700 nm, and particularly light having a wavelength of 1450 nm to 1650 nm.

The metamaterial according to the present disclosure can exhibit a zero refractive index for light in such a wavelength range.

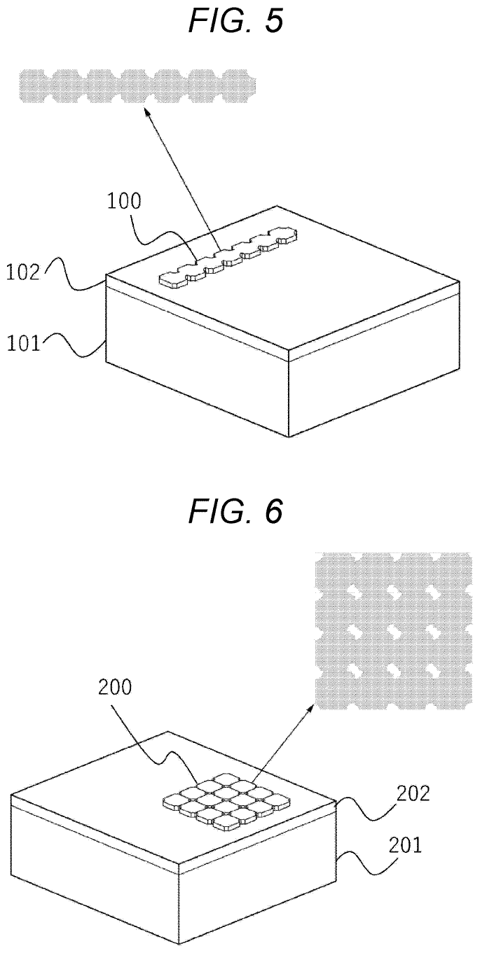

An example of a metamaterial according to the present disclosure in which resonators are arranged one-dimensionally will be described with reference to FIG. 5.

A metamaterial 100 illustrated in this drawing is configured by a plurality of resonators according to the present disclosure arranged one-dimensionally. As described in 1 above, the metamaterial may be provided on the substrate 101, and particularly may be provided on the SiO₂ film 102 laminated on the substrate 101.

Note that, in the drawing, seven resonators are one-dimensionally arranged, but this is merely illustrated for convenience of description of the present disclosure, and the metamaterial according to the present disclosure may have the number of resonators and the arrangement of the resonators appropriately changed according to a device (for example, an optical device) to which the metamaterial is applied.

An example of a metamaterial according to the present disclosure in which resonators are arranged two-dimensionally will be described with reference to FIG. 6.

A metamaterial 200 in accordance with the present disclosure as illustrated in the drawing includes a plurality of resonators in accordance with the present disclosure that is arranged two-dimensionally. Note that, in the drawing, 16 resonators are two-dimensionally arranged, but this is merely illustrated for convenience of description of the present disclosure, and the metamaterial according to the present disclosure may have the number of resonators and the arrangement of the resonators appropriately changed according to a device (for example, an optical device) to which the metamaterial is applied. As described in 1 above, the metamaterial may be provided on a substrate 201, and particularly may be provided on a SiO₂ film 202 laminated on the substrate 201.

### 3. Third Embodiment (Optical Element and Optical Device)

The metamaterial according to the present disclosure may be used as an element of various optical elements and optical devices. That is, the present disclosure also provides an optical element including a metamaterial according to the present disclosure. In addition, the present disclosure also provides an optical device including a metamaterial according to the present disclosure.

The optical element may be, for example, a waveguide itself including a metamaterial according to the present disclosure, or may be an optical element including the waveguide. In the waveguide, a plurality of resonators according to the present disclosure may be arranged one-dimensionally. The waveguide may include a plurality of resonators according to the present disclosure arranged one-dimensionally. The optical element may be used, for example, for optical communication, that is, may be used as a waveguide for transmitting optical data.

In addition, in the optical element, the metamaterial according to the present disclosure may be provided on a surface on which light is incident or reflected. In these aspects, the resonators according to the present disclosure may be arranged two-dimensionally. The optical element may be, for example, but not limited to, a mirror, a lens, a prism, a filter, or a beam splitter.

The optical device includes, for example, an optical circuit, an optical communication module, an optical information processing device, an optical information processing system, a sensor device, a measurement device (for example, LiDAR), a sensing system, a laser, a cloaking device, a non-linear optical device, quantum emitters, and a device utilizing super-radiance. An optical device in accordance with the present disclosure may be, but is not limited to, any of the listed devices.

In a case where the optical device according to the present disclosure is an optical circuit, the optical circuit may include a metamaterial according to the present disclosure, for example, as a material forming at least a part of a waveguide. In addition, the optical circuit may have an optical element including a metamaterial according to the present disclosure.

In a case where the optical device according to the present disclosure is an optical communication module, an optical information processing device, or an optical information processing system, the optical information processing device or the optical information processing system may include, for example, an optical element including a metamaterial according to the present disclosure, or may include an optical circuit including a metamaterial according to the present disclosure.

In the optical circuit, the optical information processing device, and the optical information processing system, the waveguide according to the present disclosure may be used to transmit optical data, for example.

The optical information processing device may mean, for example, one device that processes optical data. The optical information processing system may mean, for example, a system including at least one device that processes optical data. That is, the system may include two or more devices, and at least one of the two or more devices is a device that processes optical data.

In a case where the optical device according to the present disclosure is a sensor device, the measurement device (for example, LiDAR), a sensing system, a laser, or a cloaking device, these optical devices may have an optical element including a metamaterial according to the present disclosure, for example. The optical element may be, but is not limited to, the mirror, the lens, the prism, the filter, or the beam splitter described above.

In a case where the optical device according to the present disclosure is a non-linear optical device, a quantum emitter, and a device utilizing super-radiance (such as a super-radiant light source), these optical devices may include, for example, an optical element including a metamaterial according to the present disclosure, or may include a waveguide including a metamaterial according to the present disclosure.

### 4. Examples

### 4-1. Example 1 (Exhibition of Zero Refractive Index in One-Dimensional Waveguide)

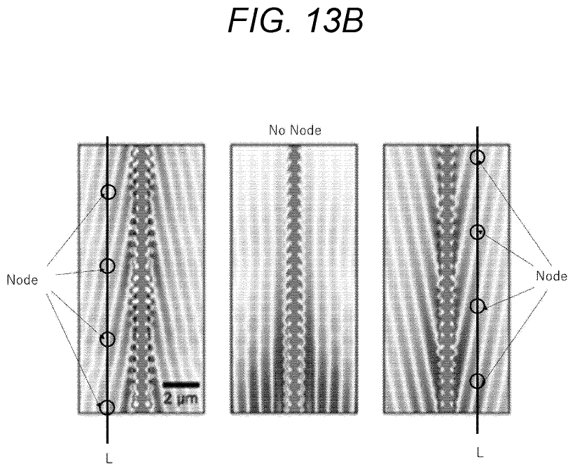

As described in 1-1 above, a mode based on Dirac cone dispersion can be generated by optimizing the size of air hole and the array period. Simulation has been performed on a waveguide in which resonators having the structure described above with reference to FIG. 2 are one-dimensionally arranged. The simulation has been performed by a finite-difference time-domain method using FullWAVE (Synopsys Optical Solutions Group). The waveguide on which the simulation has been performed is as illustrated in FIG. 2. In the simulation, as illustrated in FIG. 13A, light beams of various wavelengths (TE polarized perpendicular incident light) have been introduced from one side (the left end in the drawing) of the waveguide WG toward the arrangement direction. The boundary condition of the simulation region in the simulation has been set to be a perfect matching layer. By this simulation, a result as illustrated in FIG. 13B has been obtained. From the result, the inter-node distance has been specified, and the refractive index has been calculated on the basis of the inter-node distance. As illustrated in the drawing, a plurality of nodes is identified on a line L parallel to the incident light. The inter-node distance corresponds to the distance between the two closest nodes among these specified nodes.

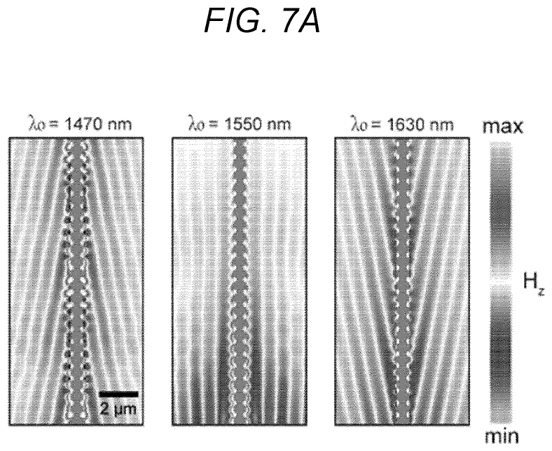

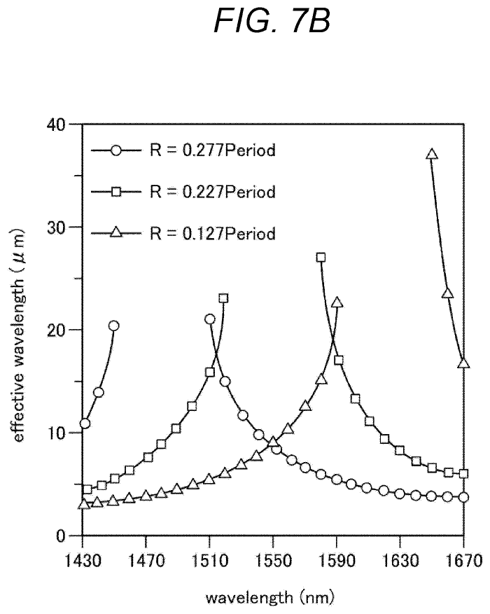

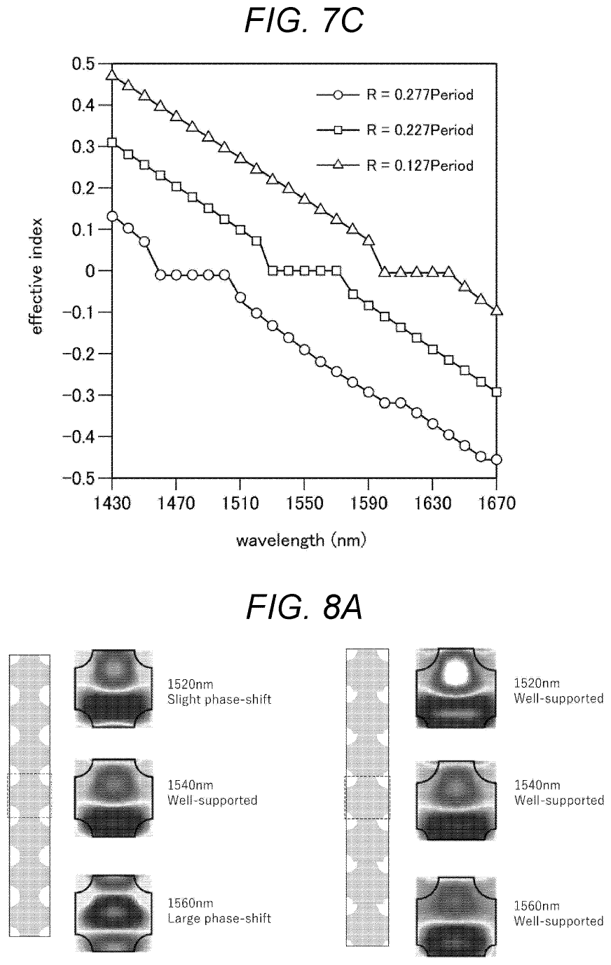

In the simulation, when the array period of the resonators in the waveguide illustrated in the drawing is P and the radius of the air hole is R, P=640 nm and R=0.227×P=145 nm are set. In the waveguide, it has been confirmed that a zero refractive index has been exhibited IN a case where light having a wavelength of 1550 nm has been incident. This is illustrated in FIG. 7A. The drawing shows the distribution of the out-of-plane magnetic field Hz.

In a case where light having a wavelength of 1550 nm is incident on the waveguide, three types of target modes at Γ point which is a center point of a Brillouin zone are degenerated, and photonic Dirac cone dispersion occurs. In this Dirac cone dispersion, the wave vector k of the specific wavelength at the Γ point is 0. k=0 at the Γ point means that the relative permittivity and relative permeability of the medium both become 0, and as a result, the refractive index becomes 0.

In Non-Patent Document 1 described above, it is illustrated that the waveguide based on the Dirac Cone dispersion designed in this way actually exhibits a zero refractive index and an infinite wavelength. However, the relative bandwidth in which the waveguide described above exhibits a zero refractive index is as very small as about 2%.

In the waveguide from which the measurement result of FIG. 7A has been obtained, the radius R of the air hole is R=0.227×P=145 nm. Waveguides in the case of other air hole radii have been also prepared. These are R=0.277×P=177 nm and R=0.127×P=81 nm. Also for the waveguides in the case of these air hole radii, a Dirac cone mode occurs at the Γ point at a specific wavelength.

The effective wavelength and the refractive index in each case where R is 0.277P (=177 nm), 0.227P (=145 nm), and 0.127P (=81 nm) have been specified. As illustrated in FIGS. 7B and 7C, infinite wavelength and zero refractive index are exhibited in a specific wavelength range for each air hole radius. That is, by setting the air hole radius R to 0.277P (R=177 nm) and 0.127P (R=81 nm) with respect to the array period P for each of the wavelengths of 1480 nm and 1620 nm, infinite wavelength and zero refractive index can be exhibited for each wavelength.

Next, simulation has been performed on a one-dimensional waveguide in which resonators having a structure in which two types of air holes specified as described above are combined are arranged. The resonator has a structure as illustrated in FIG. 1B. That is, in the drawing, simulation is performed on a waveguide in which resonators in which R1 is 0.127P (=81 nm) and R2 is 0.277P (177 nm) are arranged.

It is considered that the zero refractive index is exhibited when the magnetic dipole indicating the establishment of the Dirac Cone mode is confirmed in addition to the absence of the phase change.

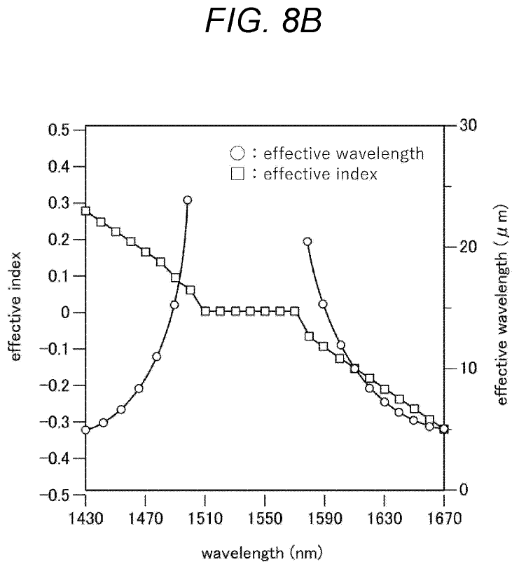

On the right of FIG. 8A, the distribution of the out-of-plane magnetic field in a waveguide according to the present disclosure having the composite structure is illustrated. In the waveguide (resonator), as illustrated in this drawing, in any of the cases of 1520 nm, 1540 nm, and 1560 nm, a magnetic dipole indicating exhibition of the Dirac Cone mode has been confirmed, but a change in phase of propagating infrared light has not been confirmed. Therefore, it has been confirmed that a zero refractive index is exhibited in a wide band.

On the left of FIG. 8A, the distribution of the out-of-plane magnetic field in the one-dimensional waveguide in which the resonator having only one type of air hole is arranged is illustrated. In the waveguide, at 1520 nm, a magnetic dipole has been confirmed, and it has been confirmed that the phase has been slightly changed. At 1540 nm, the magnetic dipole has been confirmed, and a phase change has not been confirmed. At 1560 nm, no magnetic dipole has been observed, and a significant phase change has been observed. As described above, it has been confirmed that the zero refractive index is exhibited only in a narrow band.

The simulation of the effective wavelength and the refractive index in the waveguide having the composite structure has been performed in the similar manner as described above. Simulation results are illustrated in FIG. 8B. As illustrated in the drawing, it can be seen that the waveguide having the composite structure exhibits a zero refractive index over a wavelength bandwidth of 105 nm (relative bandwidth 6.7%). In addition, it has been also confirmed that an infinite wavelength has been exhibited over the bandwidth. In this way, waveguides in accordance with the present disclosure can exhibit zero refractive index and infinite wavelength over a very wide bandwidth.

### 4-2. Example 2 (Exhibition of Zero Refractive Index in Two-Dimensional Array)

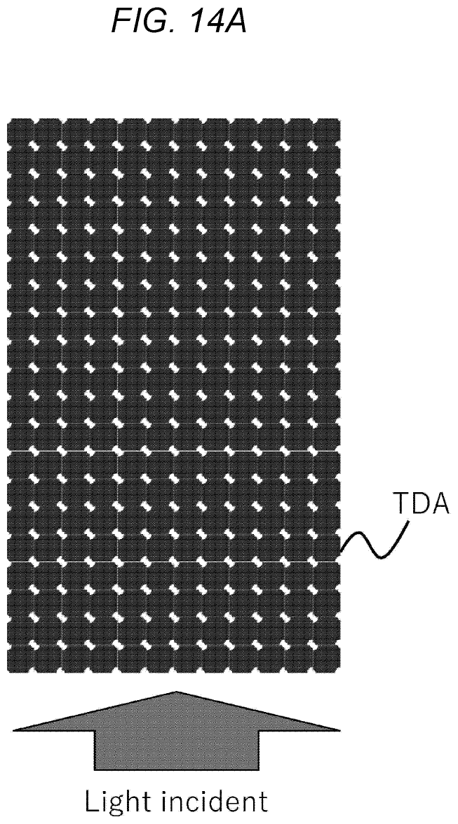

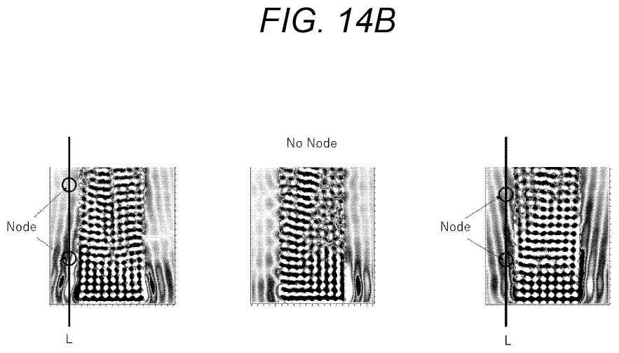

For two-dimensionally arranged resonators (two-dimensional array), simulation has been performed regarding the wavelength at which the zero refractive index is exhibited. The simulation was similarly performed using the same software as in Example 1. That is, as illustrated in FIG. 14A, light beams of various wavelengths (TE polarized perpendicular incident light) have been introduced from one side of the two-dimensional array TDA. The boundary condition of the simulation region in the simulation has been set to be a perfect matching layer. By this simulation, a result as illustrated in FIG. 14B has been obtained. From the result, the inter-node distance has been specified, and the refractive index has been calculated on the basis of the inter-node distance. As illustrated in the drawing, a plurality of nodes is identified on a line L parallel to the incident light. The inter-node distance corresponds to the distance between the two closest nodes among these specified nodes.

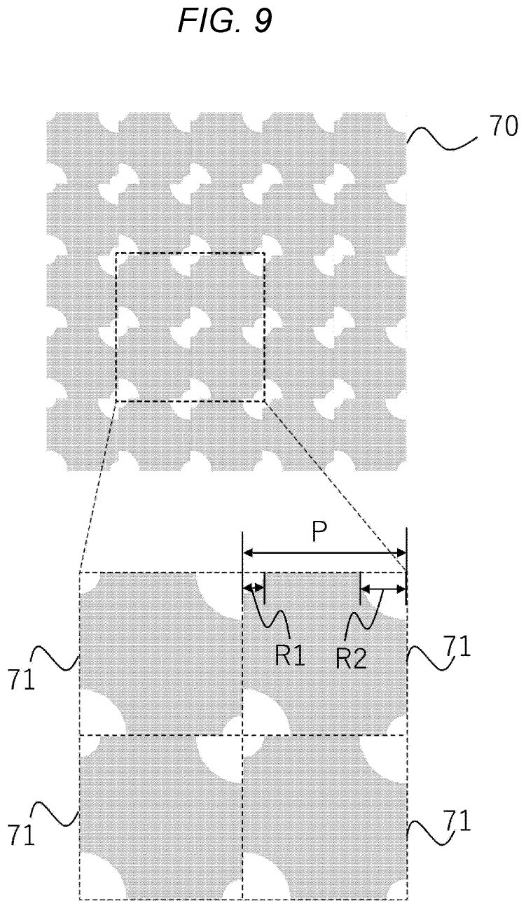

FIG. 9 illustrates a schematic view of the two-dimensional array of resonators used in the simulation. Illustrated above is a two-dimensional array 70 in which a plurality of resonators having two different types of divided air holes in accordance with the present disclosure is two-dimensionally arranged. A schematic view in which a part of the two-dimensional array is enlarged is illustrated below the drawing. As illustrated in the schematic view, the unit cells 71 are two-dimensionally arranged. The unit cell 71 is as described above in Example 1, P=640 nm, R1=0.127P=81 nm, and R2=0.277P=177 nm.

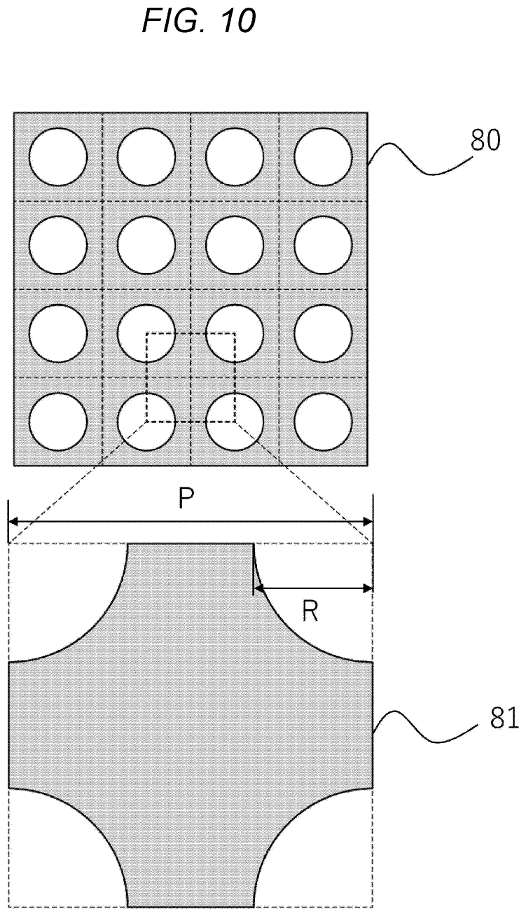

In addition, simulation has been also performed on a two-dimensional array in which a plurality of resonators having one type of divided air holes is two-dimensionally arranged. A schematic view of the two-dimensional array is illustrated in FIG. 10. Shown above is a two-dimensional array 80 in which a plurality of resonators having one type of divided air holes in accordance with the present disclosure is two-dimensionally arranged. A schematic view in which a part of the two-dimensional array is enlarged is illustrated below the drawing. The unit cell 81 illustrated in the schematic view has P=738 nm and R=222 nm.

For these two types of resonator two-dimensional arrays, a simulation of the refractive index has been performed.

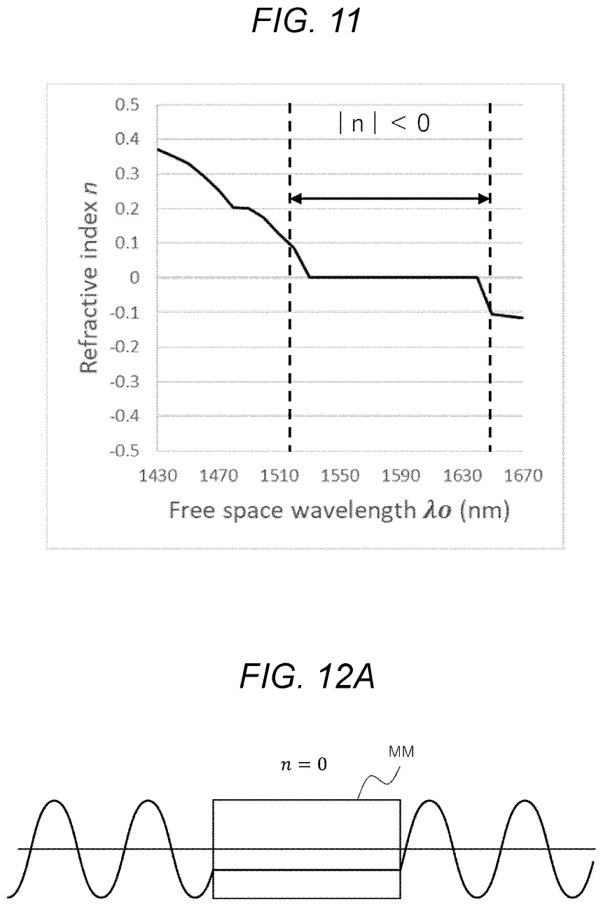

Simulation results of the refractive index for the two-dimensional array of resonators with two different divided air holes are illustrated in FIG. 11. As illustrated in the drawing, the bandwidth in which the two-dimensional array exhibits a zero refractive index has been 135 nm, and the relative bandwidth has been about 8.5%.

In addition, for the two-dimensional array of resonators having one type of divided air hole, the bandwidth for exhibiting the zero refractive index has been 43 nm, and the relative bandwidth has been about 2%.

By combining two different divided air holes, the relative bandwidth has been increased by about 325% (=(8.5−2)/2).

From the above results, the zero refractive index can be exhibited over a wide wavelength range by the two-dimensional array of resonators of the unit cell in which the two different types of divided air holes are combined.

The present disclosure can also adopt the following configurations.

[1]

A resonator including:
a plurality of divided air holes in a unit cell, in which
the plurality of divided air holes includes two or more types of divided air holes different in dimension or shape, or both.
   [2]

The resonator according to [1], in which the plurality of divided air holes is provided at respective corners of the unit cell.

[3]

The resonator according to [1] or [2], in which the divided
air hole has a shape obtained by dividing a circular, elliptical, polygonal, or star-shaped polygonal air hole.
   [4]

The resonator according to any one of [1] to [3], in which
the unit cell is a unit cell having a shape of a polygon, and
a divided air hole is provided at each of corners of the polygon.
   [5]

The resonator according to any one of [1] to [4], in which a size of the resonator is less than or equal to 800 nm.

[6]

The resonator according to any one of [1] to [5], in which sizes of the two or more types of divided air holes are 0.01 to 0.5 in a case where a size of the resonator is 1.

[7]

A metamaterial including:
a resonator provided with a plurality of divided air holes in a unit cell, in which
the plurality of divided air holes provided in each of the resonators includes two or more types of divided air holes different in dimension or shape, or both.
   [8]

The metamaterial according to [7], in which the plurality of divided air holes is provided at respective corners of the unit cell.

[9]

The metamaterial according to [7] or [8], in which the resonators are arranged one-dimensionally or two-dimensionally.

[10]

The metamaterial according to any one of [7] to [9], in which the resonators are periodically arranged.

[11]

The metamaterial according to any one of [7] to [10], in which the resonators are arranged such that at least two types of divided air holes are connected to form one air hole.

[12]

The metamaterial according to any one of [7] to [11], in which a relative bandwidth is greater than or equal to 5%.

[13]

The metamaterial according to any one of [7] to [12], in which a wavelength range over which the metamaterial exhibits a zero refractive index is greater than or equal to 50 nm.

[14]

The metamaterial according to any one of [7] to [13], in which each of the two or more types of divided air holes is a divided air hole configured to exhibit a zero refractive index in a case where only one type of divided air hole is provided in all corners of the unit cell.

[15]

The metamaterial according to any one of [7] to [14], in which the metamaterial exhibits a zero refractive index with respect to a wavelength of infrared light.

[16]

The metamaterial of any one of [7] to [15], in which the metamaterial is a Dirac cone zero refractive index material.

[17]

An optical element including: the metamaterial according to any one of [7] to [16].

[18]

The optical element according to [17], in which the optical element is a waveguide.

[19]

An optical device including: the metamaterial according to any one of [7] to [16].

[20]

The optical device according to [19], in which the optical device is any of an optical circuit, an optical communication module, an optical information processing device, an optical information processing system, a sensor device, a measurement device, a sensing system, a laser, a cloaking device, a non-linear optical device, a quantum emitter, a beam steering device, and a device utilizing super-radiance.

Although the embodiments and examples of the present disclosure have been specifically described above, the present disclosure is not limited to the above-described embodiments and examples, and various modifications based on the technical idea of the present disclosure are possible.

For example, the configurations, the methods, the steps, the shapes, the materials, the numerical values, and the like described in the embodiments and examples described above are merely examples, and different configurations, methods, steps, shapes, materials, numerical values, and the like may be used as needed. In addition, the configurations, methods, steps, shapes, materials, numerical values, and the like of the above-described embodiments and examples can be combined with each other without departing from the gist of the present disclosure.

In addition, in the present specification, a numerical range indicated by using “to” indicates a range including numerical values described before and after “to” as the minimum value and the maximum value, respectively. In the numerical ranges described in stages in the present specification, the upper limit value or the lower limit value of a numerical range of a certain stage may be replaced with the upper limit value or the lower limit value of a numerical range of another stage.

### REFERENCE SIGNS LIST

10 Resonator
11 Unit cell
12, 13, 14, 15 Divided air hole
20 Metamaterial

1. A resonator comprising:
a plurality of divided air holes in a unit cell, wherein
the plurality of divided air holes includes two or more types of divided air holes different in dimension or shape, or both.

2. The resonator according to claim 1, wherein the plurality of divided air holes is provided at respective corners of the unit cell.

3. The resonator according to claim 1, wherein the plurality of divided air holes has a shape obtained by dividing a circular, elliptical, polygonal, or star-shaped polygonal air hole.

4. The resonator according to claim 1, wherein
the unit cell is a unit cell having a shape of a polygon, and
a divided air hole is provided at each of corners of the polygon.

5. The resonator according to claim 1, wherein a size of the resonator is less than or equal to 800 nm.

6. The resonator according to claim 1, wherein sizes of the two or more types of divided air holes are 0.01 to 0.5 in a case where a size of the resonator is 1.

7. A metamaterial comprising:
a resonator provided with a plurality of divided air holes in a unit cell, wherein
the plurality of divided air holes provided in each of the resonators includes two or more types of divided air holes different in dimension or shape, or both.

8. The metamaterial according to claim 7, wherein the plurality of divided air holes is provided at respective corners of the unit cell.

9. The metamaterial according to claim 7, wherein the resonators are arranged one-dimensionally or two-dimensionally.

10. The metamaterial according to claim 7, wherein the resonators are periodically arranged.

11. The metamaterial according to claim 7, wherein the resonators are arranged such that at least two types of divided air holes are connected to form one air hole.

12. The metamaterial according to claim 7, wherein a relative bandwidth is greater than or equal to 5%.

13. The metamaterial according to claim 7, wherein a wavelength range over which the metamaterial exhibits a zero refractive index is greater than or equal to 50 nm.

14. The metamaterial according to claim 7, wherein each of the two or more types of divided air holes is a divided air hole configured to exhibit a zero refractive index in a case where only one type of divided air hole is provided in all corners of the unit cell.

15. The metamaterial according to claim 7, wherein the metamaterial exhibits a zero refractive index with respect to infrared light.

16. The metamaterial of claim 7, wherein the metamaterial is a Dirac cone zero refractive index material.

17. An optical element comprising: the metamaterial according to claim 7.

18. The optical element according to claim 17, wherein the optical element is a waveguide.

19. An optical device comprising: the metamaterial according to claim 7.

20. The optical device according to claim 19, wherein the optical device is any of an optical circuit, an optical communication module, an optical information processing device, an optical information processing system, a sensor device, a measurement device, a sensing system, a laser, a cloaking device, a non-linear optical device, a quantum emitter, a beam steering device, and a device utilizing super-radiance.
